(19) United States
(12) Patent Application Publication
(10) Pub. No.: US 2011/0102814 A1
(43) Pub. Date: May 5, 2011

(54) MOVEMENT DETECTION APPARATUS AND RECORDING APPARATUS

(75) Inventor: Koji Okamura, Kawasaki-shi (JP)

(73) Assignee: CANON KABUSHIKI KAISHA, Tokyo (JP)

(21) Appl. No.: 12/911,584

(22) Filed: Oct. 25, 2010

(30) Foreign Application Priority Data
Oct. 30, 2009 (JP) 2009-250827

(51) Int. Cl. G06F 15/00; H04N 7/18

(52) U.S. Cl. 358/1.5; 348/142; 348/E07.085

(57) ABSTRACT

An apparatus extracts a template pattern from first data, and seek an area having a correlation with the template pattern among areas in second data to obtain an amount of movement of an object, and corrects the amount of movement by using a shift amount of the object during a time lag between the generation timing of a trigger signal for acquiring data by using a sensor, and the imaging timing.

### BACKGROUND OF THE INVENTION

1. Field of the Invention

The present invention relates to a technique for detecting the movement of an object through image processing, and to a technical field of a recording apparatus.

2. Description of the Related Art

When performing printing on a medium such as a print sheet while it is being conveyed, a low conveyance precision causes an uneven density of a halftone image or a magnification error, resulting in degraded quality of a printed image. Therefore, although recording apparatuses employ high-precision components and carry an accurate conveyance mechanism, there is a strong demand for higher print quality and higher conveyance precision. At the same time, there is also a strong demand for cost reduction. The achievement of both higher precision and lower cost is demanded.

To meet this demand, an attempt is made to detect the movement of a medium with high precision to achieve stable conveyance through feedback control. A method used in this attempt, also referred to as direct sensing, images the surface of the medium to detect through image processing the movement of the medium being conveyed.

Japanese Patent Application Laid-Open No. 2007-217176 discusses a method for detecting the movement of the medium. The method in Japanese Patent Application Laid-Open No. 2007-217176 images the surface of a moving medium a plurality of times in a time sequential manner by using an image sensor, and compares acquired images through pattern matching to detect an amount of movement of the medium. Hereinafter, a method for directly detecting the surface of an object to detect its moving state is referred to as direct sensing, and a detector employing this method is referred to as a direct sensor.

However, the image sensor involves a slight time lag since the time when an imaging trigger signal is generated until the time when the imaging sensor actually starts imaging. The time lag refers to a time period during which the imaging trigger signal is generated, the image sensor opens an electronic shutter in response to this signal to start exposure, and a center timing of the exposure period comes (the center timing is referred to as imaging timing in the present specification). If the medium moves during this time lag, the obtained image data will contain an error corresponding to the shift amount during the time lag. The higher the conveyance speed, the larger the shift amount during the time lag and accordingly the more noticeable becomes the error.

With direct sensing, a relative amount of movement between first and second image data is calculated through an image comparison method such as pattern matching. In this case, if both the first and second image data shift by the same amount during the time lag, a relative difference between the two pieces of data remains unchanged. However, when the moving speed of the medium at the time of first image data acquisition differs from that at the time of second image data acquisition, the shift amount during the time lag (equals the time lag multiplied by the average moving speed during the time lag) becomes different even with the same time lag. Therefore, a relative gap arises between the first and second image data, and the gap may cause an error in detecting an amount of movement through pattern matching.

The present invention has been devised based on the recognition of the above-mentioned problem.

### SUMMARY OF THE INVENTION

According to an aspect of the present invention, an apparatus includes: a configured to capture an image of the surface of a moving object to acquire first and second data; and a processing unit configured to extract a template pattern from the first data, and seek an area having a correlation with the template pattern among areas in the second data to obtain an amount of movement of the object, wherein the processing unit corrects the amount of movement by using a shift amount of the object during a time lag between generation timing of a trigger signal for acquiring data by using the sensor, and the imaging timing.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a sectional view of a printer according to an exemplary embodiment of the present invention.

FIG. 2 is a sectional view of the printer according to a modification.

FIG. 3 is a system block diagram of the printer.

FIG. 4 illustrates a configuration of a direct sensor.

FIG. 5 is a flow chart illustrating processing of medium feeding, recording, and discharging.

FIG. 6 is a flow chart illustrating processing of medium conveyance in a step feeding manner.

FIG. 7 illustrates processing for obtaining an amount of movement of a medium by pattern matching.

FIG. 8 illustrates an effect of detection delay by a time lag involved in an image sensor.

FIG. 9 illustrates a concept of a correction method (first correction method) in consideration of a shift amount.

FIG. 10 illustrates a concept of another correction method (second correction method) in consideration of a shift amount.

FIG. 11 illustrates a concept of a still another correction method (third correction method) in consideration of a shift amount.

FIG. 12 (including FIG. 12A and FIG. 12B) is a flow chart illustrating processing of the second correction method.

FIG. 13 (including FIG. 13A and FIG. 13B) is a flow chart illustrating processing of the third correction method.

### DESCRIPTION OF THE EMBODIMENTS

Various exemplary embodiments, features, and aspects of the invention will be described in detail below with reference to the drawings. However, the components described in the following exemplary embodiments are illustrative and are not meant to limit the scope of the present invention. The scope of the present invention widely ranges from a printer to a field of movement detection requiring high-precision detection of the movement of an object. For example, the present invention is applicable to printers, scanners, and other devices used in technical, industrial, and physical distribution fields for conveying an object and performing inspection, reading, processing, marking, and other various pieces of processing to the object. Further, the present invention is applicable to diverse types of printers including ink jet printers, electrophotographic printers, thermal printers, and dot impact printers. In the present specification, a medium means a sheet-like or plate-shaped medium such as paper, a plastic sheet, a film, glass, ceramics, resin, and so on. Further, in the present specification, the upstream and downstream sides mean the sides of upstream and downstream of the sheet conveyance direction at the time of image recording on a sheet.

An embodiment of an ink jet printer which is an exemplary recording apparatus will be described below. The printer according to the present exemplary embodiment is termed a serial printer which alternately performs main scanning and sub scanning to form a two-dimensional image. With main scanning, the printer reciprocally moves a print head. With sub scanning, the printer conveys a medium in a stepwise feeding by a predetermined amount. The present invention is applicable not only to a serial printer but also to a line printer having a full line print head covering the print width for moving a medium with respect to the fixed print head to form a two-dimensional image.

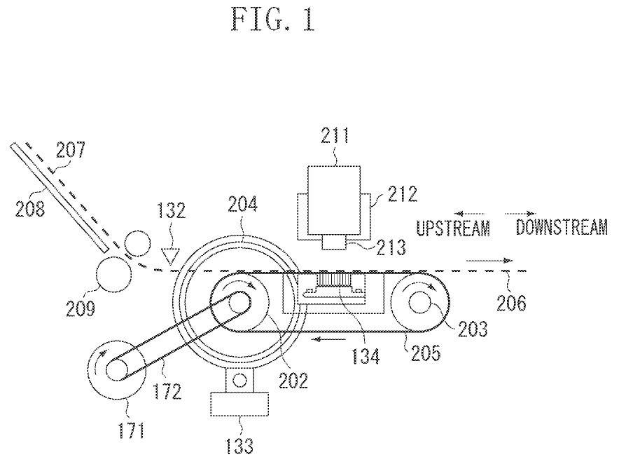

FIG. 1 is a sectional view illustrating a configuration of an essential part of a printer. The printer includes a conveyance mechanism for moving the medium in the sub scanning direction (first direction or a predetermined direction) by a belt conveyance system, and a recording unit configured to perform recording on the moving medium by using a print head. The printer further includes a rotary encoder 133 configured to indirectly detect a moving state of an object, and a direct sensor 134 configured to directly detect the moving state of the object.

The conveyance mechanism includes a first roller 202 and a second roller 203 which are rotating members, and a wide conveyance belt 205 applied between the first and second rollers by a predetermined tension. A medium 206 adhering to the surface of the conveyance belt 205 by electrostatic attraction or adhesion is conveyed by the movement of the conveyance belt 205. The rotational force of the conveyance motor 171, a driving source for sub scanning, is transmitted to the first roller 202, i.e., a drive roller, via the drive belt 172 to rotate the first roller 202. The first roller 202 and the second roller 203 rotate in synchronization with each other via the conveyance belt 205. The conveyance mechanism further includes a feed roller pair 209 for separating one medium from media 207 loaded on a tray 208 and feeding it onto the conveyance belt 205, and a feed motor 161 (not illustrated in FIG. 1) for driving the feed roller pair 209. A paper end sensor 132 disposed on the downstream side of the feed motor 161 detects a leading edge or trailing edge of a medium to acquire a timing of medium conveyance.

The rotary encoder (rotational angle sensor) 133 is used to detect a rotating state of the first roller 202 to indirectly acquire the moving state of the conveyance belt 205. The rotary encoder 133 including a photograph interrupter optically reads slits circumferentially arranged at equal intervals on a code wheel 204 coaxially attached to the first roller 202 to generate a pulse signal.

The direct sensor 134 is disposed below the conveyance belt 205 (on the rear surface side of the medium 206, i.e., the side opposite to the side on which the medium 206 is loaded). The direct sensor 134 includes an image sensor (imaging device) for capturing an image of an area containing markers on the surface of the conveyance belt 205. The direct sensor 134 directly detects a moving state of the conveyance belt 205 through image processing to be described below. Since the medium 206 firmly sticks to the surface of the conveyance belt 205, a variation in the relative position by the slip between the surface of the conveyance belt 205 and the medium 206 is vanishingly small. Therefore, it is assumed that the direct sensor 134 can directly detect a moving state of the medium 206. The function of direct sensor 134 is not limited to capturing an image of the rear surface of the conveyance belt 205, but may be configured to image an area on the front surface of the conveyance belt 205 not covered by the medium 206. Further, the direct sensor 134 may capture an image of the surface of medium 206 instead of the surface of the conveyance belt 205.

The recording unit includes a carriage 212 reciprocally moving in the main scanning direction, a print head 213, and an ink tank 211, the latter two being mounted on the carriage 212. The carriage 212 reciprocally moves in the main scanning direction (second direction) by the driving force of a main scanning motor 151 (not illustrated in FIG. 1). Nozzles of the print head 213 discharge ink in synchronization with the movement of the carriage 212 to perform printing on the medium 206. The print head 213 and the ink tank 211 may be detachably attached to the carriage 212 either integrally as one unit or individually as separate components. The print head 213 discharges ink through the ink jet method. The ink discharge method may be based on a heater element, a piezo-electric element, an electrostatic element, an MEMS element, and so on.

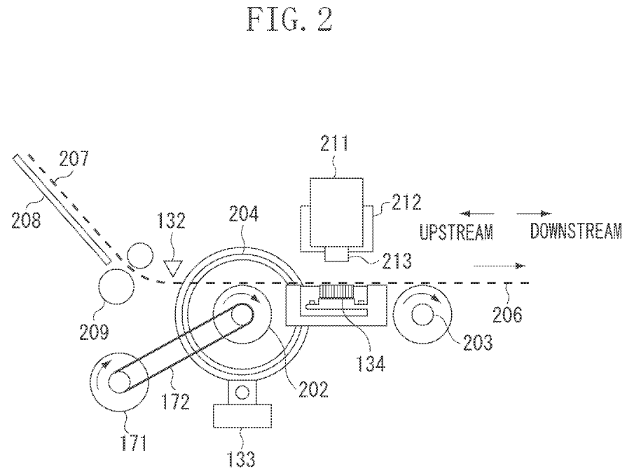

The conveyance mechanism is not limited to the belt conveyance system, but may include, as a modification, a mechanism for conveying a medium by using a conveyance roller instead of a conveyance belt. FIG. 2 illustrates a sectional view of the printer according to the modification. Referring to FIG. 2, members assigned the same reference numerals are identical to those of FIG. 1. The first roller 202 and the second roller 203 directly contact the medium 206 to move it. A synchronous belt (not illustrated) is applied between the first roller 202 and the second roller 203 so that the second roller 203 rotates in synchronization with the rotation of the first roller 202. In this modification, the direct sensor 134 images the rear surface of the medium 206 instead of the conveyance belt 205.

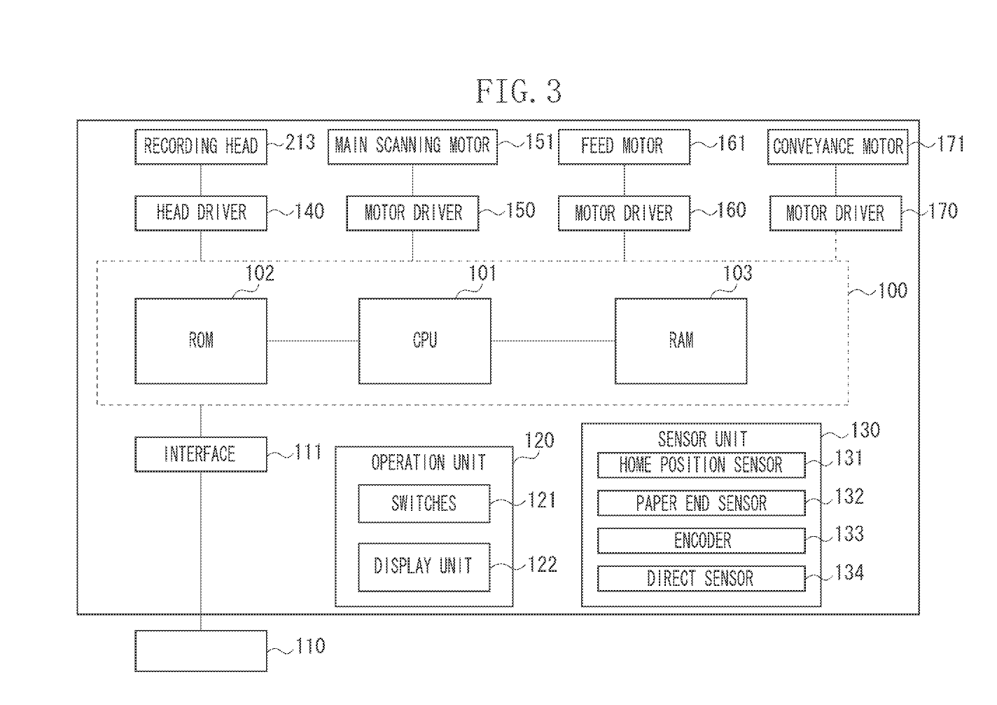

FIG. 3 is a system block diagram of the printer. A controller 100 includes a central processing unit (CPU) 101, a read-only memory (ROM) 102, and a random access memory (RAM) 103. The controller 100 serves also as a control unit and a processing unit to perform various control of the entire printer as well as image processing. An information processing apparatus 110 is an apparatus which supplies image data to be recorded on an medium, such as a computer, a digital camera, a TV, and a mobile phone. The information processing apparatus 110 is connected with the controller 100 via an interface 111. An operation unit 120, which is a user interface for an operator, includes various input switches 121 including a power switch and a display unit 122. A sensor unit 130 includes various sensors for detecting various states of the printer. A home position sensor 131 detects the home position of the carriage 212 reciprocally moving. The sensor unit 130 includes the above-mentioned paper end sensor 132, the rotary encoder 133, and the direct sensor 134. Each of these sensors is connected to the controller 100. Based on commands of the controller 100, the print head and various motors for the printer are driven via respective drivers. A head driver 140 drives the print head 213 according to record data. A motor driver 150 drives the main scanning motor 151. A motor driver 160 drives the feed motor 161. A motor driver 170 drives the conveyance motor 171 for sub scanning.

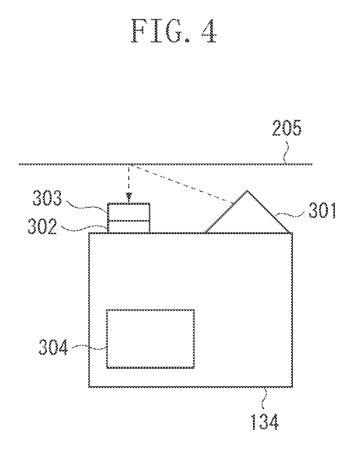

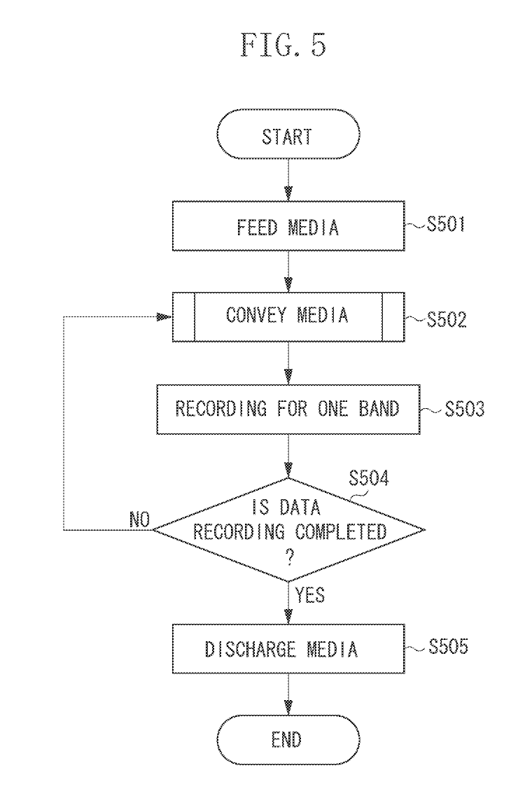

FIG. 4 illustrates a configuration of the direct sensor 134 for performing direct sensing. The direct sensor 134 is a single sensor unit which includes a light-emitting unit including a light source 301 such as a light-emitting diode (LED), an organic light-emitting diode (OLED), and a semiconductor laser; a light receiving unit including an image sensor 302 and a refractive-index distribution lens array 303; and a circuit unit 304 such as a drive circuit and an A/D converter circuit. The light source 301 illuminates a part of the rear surface of the conveyance belt 205 which is an image capture target. The image sensor 302 images via the refractive-index distribution lens array 303 a predetermined imaging area illuminated by the light source 301. The image sensor 302 is a two-dimensional area sensor such as a CCD image sensor and a CMOS image sensor, or a line sensor. An analog signal from the image sensor 302 is converted to digital form and captured as digital image data. The image sensor 302 is used to image the surface of an object (conveyance belt 205) and acquire a plurality of pieces of image data at different timings (these pieces of image data acquired in succession are referred to as first and second image data). As described below, by extracting a template pattern from the first image data, and seeking an area in the second image data having a large correlation with the extracted template pattern through image processing, the moving state of the object can be acquired. The image processing may be performed by the controller 100 or a processing unit included in the unit of the direct sensor 134.

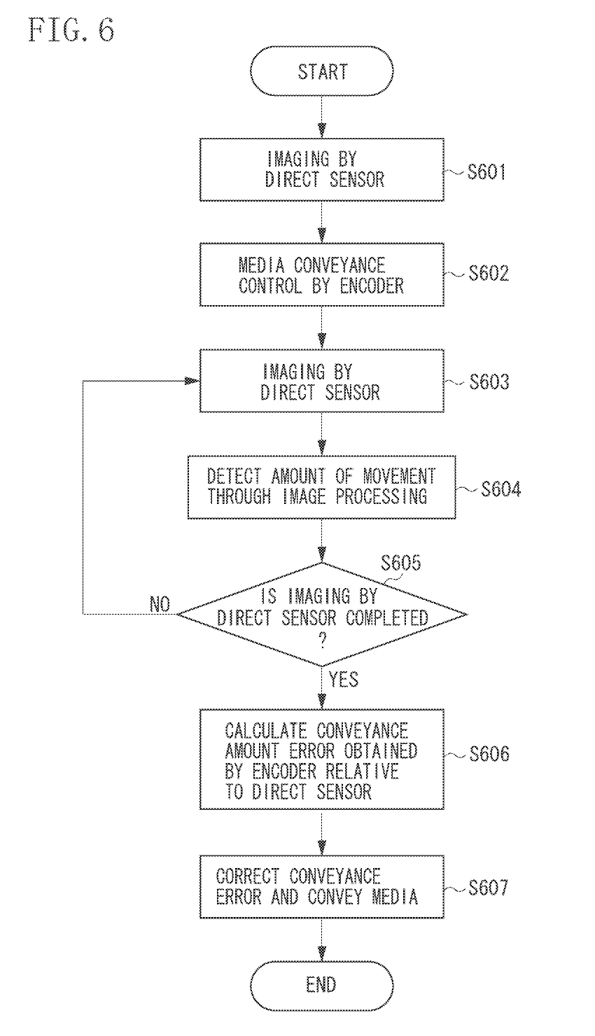

FIG. 5 is a flow chart illustrating processing of medium feeding, recording, and discharging. This processing is performed based on commands of the controller 100. In step S501, the processing drives the feed motor 161 to rotate the feed roller pair 209 to separate one medium from the medium 207 on the tray 208 and feed it along the conveyance path. When the paper end sensor 132 detects the leading edge of the medium 206 being fed, the processing performs the medium positioning operation based on the detection timing to convey the medium to a predetermined recording start position.

In step S502, the processing conveys the medium in a stepwise feeding by a predetermined amount by using the conveyance belt 205. The predetermined amount equals the length in the sub scanning direction in recording of one band (one main scanning of the print head). For example, when performing multipass recording in a two-pass manner while causing each stepwise feeding by the length of a half of the nozzle array width in the sub scanning direction of the print head 213, the predetermined amount equals the length of a half of the nozzle array width.

In step S503, the processing performs recording for one band while moving the print head 213 in the main scanning direction by the carriage 212. In step S504, the processing determines whether recording of all record data is completed. When the processing determines that recording is not completed (NO in step S504), the processing returns to step S502 to repeat recording in a stepwise feeding (sub scanning) and one band (one main scanning). When the processing determines that recording is completed (YES in step S504), the processing proceeds to step S505. In step S505, the processing discharges the medium 206 from the recording unit, thus forming a two-dimensional image on the medium 206.

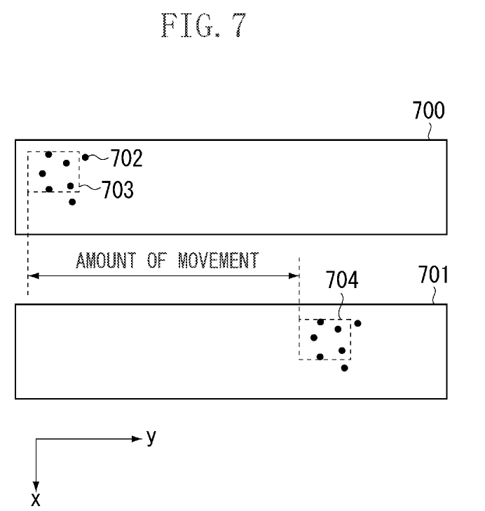

Processing of stepwise feeding in step S502 will be described in detail below with reference to the flow chart illustrated in FIG. 6. In step S601, an image of an area containing markers of the conveyance belt 205 is captured by using the image sensor of the direct sensor 134. The acquired image data denotes the position of the conveyance belt 205 before starting movement and is stored in the RAM 103. In step S602, while monitoring the rotating state of the roller 202 by the rotary encoder 133, the processing drives the conveyance motor 171 to move the conveyance belt 205, in other words, starts conveyance control for the medium 206. The controller 100 performs servo control so that the medium 206 is conveyed by a target conveyance amount. The processing executes step S603 and subsequent steps in parallel with the medium conveyance control using the rotary encoder 133.

In step S603, an image of the conveyance belt 205 is captured by using the direct sensor 134. Specifically, the processing starts imaging the conveyance belt 205 when the medium is assumed to have been conveyed by a predetermined amount based on the target amount of medium conveyance (hereinafter referred to as target conveyance amount) necessary to perform recording for one band, the image sensor width in the first direction, and the conveyance speed. In this example, a specific slit on the code wheel 204 to be detected by the rotary encoder 133 when the medium has been conveyed by a predetermined conveyance amount is specified, and the processing starts imaging the conveyance belt 205 when the rotary encoder 133 detects the slit. Step S603 will be described in detail below.

In step S604, through image processing, the processing detects the distance over which the conveyance belt 205 has moved between imaging timing of the second image data in step S603 and that of the first image data in the previous step. Processing for detecting an amount of movement will be described below. An image of the conveyance belt 205 is captured the number of times predetermined for the target conveyance amount at predetermined intervals. In step S605, the processing determines whether the image of the conveyance belt 205 has been captured the predetermined number of times. When the image of the conveyance belt 205 has not been captured the predetermined number of times (NO in step S605), the processing returns to step S603 to repeat processing until imaging is completed. The processing repeats the processing the predetermined number of times while accumulating a conveyance amount each time a conveyance amount is detected, thus obtaining a conveyance amount for one band from the timing of first imaging in step S601. In step S606, the processing calculates a difference between a conveyance amount acquired by the direct sensor 134 and a conveyance amount acquired by the rotary encoder 133 for one band. Since the rotary encoder 133 indirectly detects a conveyance amount while the direct sensor 134 directly detects a conveyance amount, the detection precision of the former is lower than that of the latter. Therefore, the above-mentioned difference can be recognized as a detection error of the rotary encoder 133.

In step S607, the processing corrects medium conveyance control by the detection error of the rotary encoder obtained in step S606. There are two different correction methods: a method for increasing or decreasing the current position information for medium conveyance control by the detection error, and a method for increasing or decreasing the target conveyance amount by the detection error. Either method can be employed. When the processing has accurately conveyed the medium 206 by the target conveyance amount through feedback control, the conveyance operation for one band is completed.

FIG. 7 illustrates in detail direct sensing in step S604. FIG. 7 schematically illustrates first image data 700 and second image data 701 of the conveyance belt 205 acquired in imaging by the direct sensor 134. A black dot pattern 702 (a portion having a luminance gradient) in the first image data 700 and the second image data 701 is an image of one of many markers applied to the conveyance belt 205 on a random basis or based on a predetermined rule. When the subject is a medium as is the case with the apparatus illustrated in FIG. 2, a microscopic pattern on the surface of the medium (for example, a paper fiber pattern) plays a similar role to the markers. The processing sets a template pattern 703 at an upstream position in the first image data 700, and extracts an image of this portion. When the second image data 701 is acquired, the processing searches for a position (in the second image data 701) of a pattern similar to the extracted template pattern 703. Search is made by using a technique of pattern matching. Any one of known similarity determination algorithms including sum of squared difference (SSD), sum of absolute difference (SAD), and normalized cross-correlation (NCC) can be employed. In this example, a most similar pattern is located in an area 704. The processing obtains a difference in the number of pixels of the image sensor (imaging device) in the sub scanning direction between the template pattern 703 in the first image data 700 and the area 704 in the second image data 701. By multiplying the difference in the number of pixels by the distance corresponding to one pixel, the amount of movement (conveyance amount m) can be obtained.

As mentioned above, when imaging a subject (conveyance belt 205 or medium 206) by using an image sensor to obtain first and second image data, the image sensor involves a slight time lag from the time when an imaging trigger signal is generated until the time when the imaging sensor actually starts imaging.

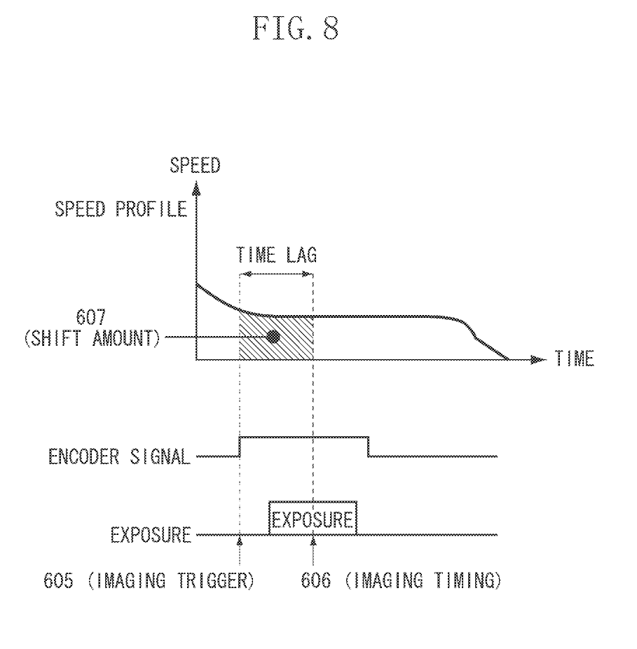

FIG. 8 illustrates an effect of a detection delay by the time lag involved in the image sensor of the direct sensor 134. A graph at the top of FIG. 8 illustrates a speed profile illustrating speed changes of the conveyance motor 171 immediately before it stops. A timing chart at the middle of FIG. 8 illustrates a detection signal output from the encoder 133. The detection signal changes between 1 and 0 each time light is transmitted through a slit on the code wheel 204 and intercepted by a non-slit portion thereon, respectively. Since slits for light transmission and non-slit portions for light interception are arranged at equal and homogenous intervals, the detection signal changes between 1 and 0 each time the subject moves a fixed distance. The amount of movement of the subject is associated with transition timing of the detection signal in terms of the diameter of the code wheel 204, the width and intervals of slits, the diameter of the conveyance roller 202, and the thickness of the subject (conveyance belt 205).

The bottom of FIG. 8 illustrates a relation between an imaging trigger signal 605 and actual imaging timing of the image sensor. The imaging trigger signal 605 instructs the image sensor to start imaging. The controller generates the imaging trigger signal 605 based on a signal transition (rising edge from 0 to 1) by the detection of a predetermined slit on the encoder 133. The direct sensor 134 starts imaging based on the imaging trigger signal 605.

Strictly speaking, processing for acquiring image data includes two different steps. In a first step, the direct sensor 134 receives the imaging trigger signal 605 which instructs the image sensor included in the direct sensor 134 to start imaging. In a second step, the image sensor opens an electronic shutter to start exposure, performs exposure during a predetermined exposure period, and outputs a captured image (through pixel reading, A/D conversion, and serial output). The center of the exposure period is illustrated as an imaging timing 606. The time lag refers to a time period between the generation timing of the imaging trigger signal 605 and the imaging timing 606. The present exemplary embodiment aims at solving problems resulting from the delay by the time lag. Since the processing for outputting a captured image by the image sensor has no influence on the imaging timing 606, the present exemplary embodiment does not consider this processing as a problem.

Since the shooting subject keeps moving during the time lag, the image sensor involves a slight positional shift between the image data at the generation timing of the imaging trigger signal 605 and the image data acquired by imaging. Further, the image data acquired by imaging includes a subject image shake in the moving direction (sub scanning direction) by the movement of the subject during the exposure period. When performing pattern matching by using the image data having a subject image shake, the amount of movement is detected with reference to the position corresponding to the imaging timing 606. A shaded portion illustrated as a shift amount 607 of FIG. 8A is an integration of the speed with respect to a time period between the generation timing of the imaging trigger signal 605 and the imaging timing 606. The area of the shaded portion represents the shift amount of the subject during the time lag. In detecting an amount of movement by pattern matching by using the first and second image data, it is necessary to correct conveyance control in consideration of this shift amount.

First Correction Method

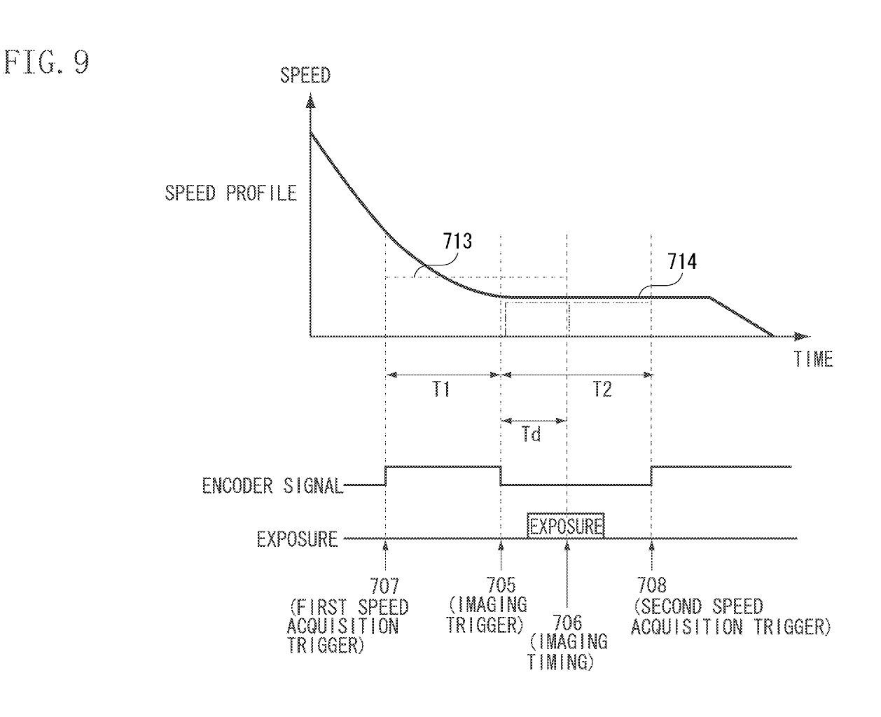

FIG. 9 illustrates a concept of a correction method (first correction method) in consideration of a shift amount. In this example, the subject is moving at a low speed. The controller generates a first speed acquisition trigger signal 707, an imaging trigger signal 705, and a second speed acquisition trigger signal 708 on successive rising and falling edges of the detection signal from the encoder 133. A time period Td between the generation timing of the imaging trigger signal 705 and an imaging timing 706 refers to the above-mentioned time lag. The amount of movement of the subject during a time period T1 between the generation timings of the first speed acquisition trigger signal 707 and the imaging trigger signal 705 is a specified value corresponding to each slit on the encoder 133 for light transmission. The amount of movement of the subject during a time period T2 between the generation timings of the imaging trigger signal 705 and the second speed acquisition trigger signal 708 is a specified value corresponding to each non-slit portion on the encoder 133 for light interception. Therefore, if a time period between the generation timings of any two trigger signals is known, an average moving speed during the time period can be obtained by dividing the amount of movement by the time period. Each time period between the generation timings of trigger signals is acquired by using a second timer described below. The time period T1 has an average moving speed 713 (first average moving speed), and the time period T2 has an average moving speed 714 (second average moving speed). Since the second average moving speed including a time period subjected to correction is likely to be more accurate than the first average moving speed, the second average moving speed will be used for correction. At a very low conveyance speed, the second speed acquisition trigger signal 708 may not have been generated before correction. In this case, correction may be performed by using the first average moving speed.

The controller includes a first timer for measuring a time lag Td and a second timer for measuring time periods T1 and T2. The processing starts the first timer at the generation timing of the imaging trigger signal 705 and then stops the first timer at the imaging timing 706 which is a center timing of the exposure period. More specifically, the processing monitors a drive signal of the light source 301 of the direct sensor 134 to obtain an exposure start timing, and determines the middle timing 706 when the center time of the exposure period (specified value) comes. In measuring the time period T1, the processing starts the second timer at the generation timing of the first speed acquisition trigger signal 707 and then stops the second timer at the generation timing of the imaging trigger signal 705. Subsequently in measuring the time period T2, the processing starts the second timer at the generation timing of the imaging trigger signal 705 and then stops the second timer at the generation timing of the second speed acquisition trigger signal 708. The time lag Td is a fixed value determined by the capability of the controller, a control circuit of the direct sensor 134, and an operation processing unit, and basically remains unchanged. Therefore, the first timer can be omitted if a premeasured or predicted time lag Td is prestored in memory.

The controller obtains an average moving speed during the time period T2 (or T1) by using a time period acquired by using the second timer. Subsequently, the controller multiplies the obtained average moving speed by the time lag Td acquired by using the first timer or prestored in memory to obtain a shift amount of the subject during the time lag Td. More specifically, the controller measures a movement time necessary for the subject to move a predetermined distance detected by the encoder 133, and divides the predetermined distance by the movement time measured using the second timer to acquire an average moving speed during the time period T2 (or T1).

A method for actually correcting the error in detecting an amount of movement by using the obtained shift amount will be described below. Each of the shift amount at the time of first image data acquisition and the shift amount at the time of second image data acquisition is obtained as mentioned above. The shift amount of the first image data is referred to as first shift amount, and the shift amount of the second image data is referred to as second shift amount. The difference between the first and second shift amounts is an error and therefore must be corrected. More specifically, the processing calculates a moving distance through the above-mentioned correlation processing by using the first and second image data, and subtracts the above-mentioned difference (the second shift amount minus the first shift amount) from the calculated moving distance to correct the error. More specifically, the controller obtains a shift amount of the first and second image data as first and second shift amount, respectively, and corrects the error by using the difference (the second shift amount minus the first shift amount) as a correction value to obtain an amount of movement of the object. If the first shift amount is the same as the second shift amount (more specifically, the moving speed of the subject is the same at the time of measurement of both shift amounts), the above-mentioned difference is zero and therefore correction is not actually performed. If either the first or second image data is stopped, the stopped image data does not involve a shift, i.e., has zero shift amount. In this case, therefore, the amount of correction equals the shift amount of the image data involving a shift.

Second Correction Method

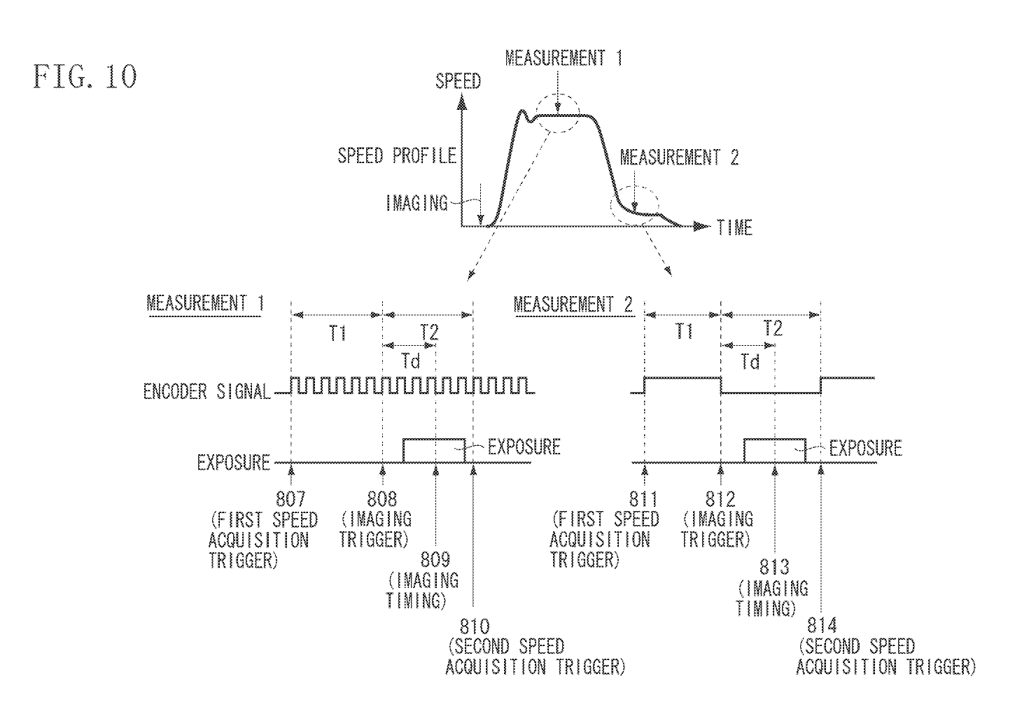

FIG. 10 illustrates a concept of another correction method (second correction method) including a case where the subject is moving at a higher speed than that in the example of FIG. 9. A graph at the top of FIG. 10 is a speed profile illustrating speed changes of the conveyance motor 171 since the time before conveyance is started until the time when conveyance is stopped. A diagram at the bottom left of FIG. 10 is a timing chart illustrating the encoder signal and exposure timing in first measurement. A diagram at the bottom right of FIG. 10 is a timing chart illustrating the encoder signal and exposure timing in second measurement. Since the timing chart for second measurement is the same as that described in FIG. 9, duplicated descriptions will be omitted.

In this example, to flexibly perform measurement at low and high speeds, imaging and correction can be preformed both in first measurement (high-speed measurement) and second measurement (low-speed measurement). A plurality of measurements maybe necessary, for example, when the conveyance amount until conveyance is stopped is longer than the length of the direct sensor 134. Further, cases where a plurality of measurements is necessary include a case where a portion unusable for measurement of the direct sensor 134 is avoided, a case where a discontinuous area of a marker on the subject is avoided, and a case where measurement during high-speed conveyance is avoided.

In first measurement, the processing obtains an amount of movement of the subject during the time lag through the above-mentioned correlation processing by using images captured before the timing of first measurement (the subject is stopped in this example) as the first image data and images captured at the timing of first measurement as the second image data. In first measurement, since the first image data is obtained while the subject is stopped, the above-mentioned shift amount (first shift amount) is zero and therefore the second shift amount serves as the above-mentioned correction value.

In second measurement, the processing obtains an amount of movement by using as the first image data the second image data acquired in first measurement and images captured at the timing of second measurement as the second image data. In second measurement, since both the first and second image data are captured while the subject is moving, both the above-mentioned shift amounts (first and second shift amounts) are larger than zero and the first shift amount is larger than the second shift amount. The difference (the second shift amount minus the first shift amount) serves as the above-mentioned correction value.

A method for obtaining a shift amount in each measurement will be described below. In first measurement, the controller generates three different trigger signals (a first speed acquisition trigger signal 807, an imaging trigger signal 808, and a second speed acquisition trigger signal 810) based on rising and falling edges of a predetermined pulse of the detection signal from the encoder 133. The time period Td between the generation timing of the imaging trigger signal 808 and the imaging timing 809 refers to the above-mentioned time lag. The amount of movement during the time period T1 between the generation timings of the first speed acquisition trigger signal 807 and the imaging trigger signal 808, and the amount of movement during the time period T2 between the generation timings of the imaging trigger signal 808 and the second speed acquisition trigger signal 810 are specified values corresponding to a plurality of slits on the encoder 133 for light transmission and interception. More specifically, the time periods T1 and T2 correspond to one slit in second measurement (low-speed measurement) and to a plurality of slits (six slits in this example) in first measurement (high-speed measurement). In other words, the processing changes the calculation algorithm based on a variable time period used for calculation to acquire average speed according to the predicted subject's speed at the imaging timing.

The amount of movement of the subject during each of the time periods T1 and T2 is a specified value corresponding to the number of the plurality of slits. Similar to the firstcorrection method, the controller measures a time duration of the time period T2 (or T1) by using the second timer, and divides the amount of movement by the measured time period to obtain an average moving speed during the time period. Subsequently, the processing multiplies the obtained average moving speed by the time lag Td acquired by using the first timer or prestored in memory to obtain a shift amount of the subject during the time lag Td.

It is preferable that the exposure end timing coincides with the generation timing of the second speed acquisition trigger signal 810. To achieve this, the processing determines the number of slits on the encoder 133 so that the time period (fixed value) between the generation timing of the imaging trigger signal 808 and the exposure end timing coincides with the time period T2.

Third Correction Method

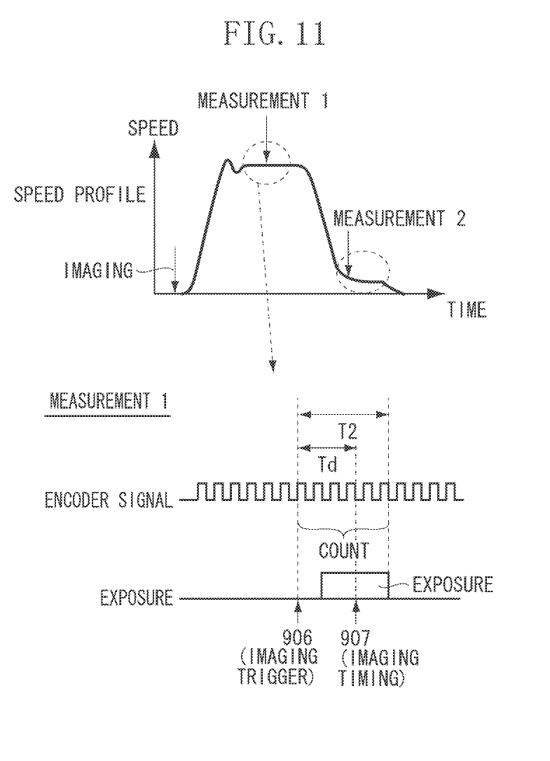

FIG. 11 illustrates a concept of a still another correction method (third correction method). The third correction method enables first measurement (high-speed measurement) and second measurement (low-speed measurement) similar to the second correction method, but differs from the second correction method in a technique of first measurement. Second measurement is not illustrated.

In first measurement (high-speed measurement), a plurality of pulse signals of the encoder 133 is generated during the time period T2 between the generation timing of the imaging trigger signal 906 and the exposure end timing. The controller counts the number of pulse signals generated during the time period T2 and calculates the amount of movement during the time period T2 based on the counted number of pulses. In this example, since the controller counts six pulse signals, the amount of movement during the time period T2 is obtained by multiplying the distance for one pulse by six. Second measurement (low-speed measurement) is similar to that in FIG. 10. More specifically, the controller changes the calculation algorithm for acquiring an average speed according to the predicted subject's speed at the imaging timing.

The controller includes the first timer for measuring the time lag Td and the second timer for measuring the time period T2. The processing starts the first timer at the generation timing of the imaging trigger signal 906 and then stops the first timer at the imaging timing 907 which is a center timing of the exposure period. The processing starts the second timer at the generation timing of the imaging trigger signal 906 and then stops the second timer at the exposure end timing (a timing at which the drive signal of the light source 301 of the direct sensor 134 becomes zero). The controller divides the amount of movement during the time period T2 by the time period T2 measured by using the second timer to obtain an average moving speed during the time period T2, and multiplies the obtained average moving speed by the time lag Td measured using the first timer to obtain a shift amount of the subject during the time lag Td. More specifically, the controller measures the time period T2 by using the second timer and detects a moving distance by using the encoder 133 during the time period between the generation timing of the imaging trigger signal 906 and the imaging end timing, and divides the detected moving distance by the time period T2 measured using the second timer to acquire an average moving speed during the time period T2.

A method for correcting the detected amount of movement by using the obtained shift amount has been described above.

Although each of the above-mentioned first, second, and third correction methods obtains an average moving speed during the time period T2 based on the detection signal from the encoder 133, equivalent information can also be obtained without using the encoder 133. For example, it is possible to presume an average moving speed during the time period T2 by using a target control value based on the speed profile used in conveyance control by the controller. It is also possible to measure a conveyance speed before (preferably immediately before) the time period T2 and consider the measured conveyance speed as an average moving speed during the time period T2.

Processing in the above-mentioned second and third correction methods will be described in detail below. The processing is performed under control of the controller 100.

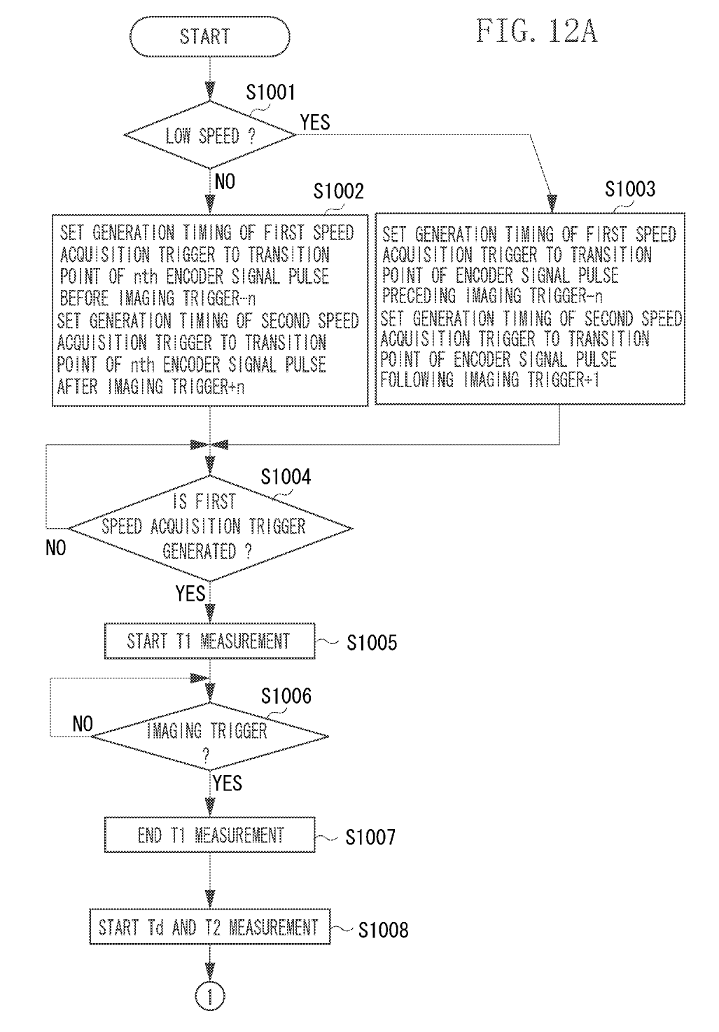

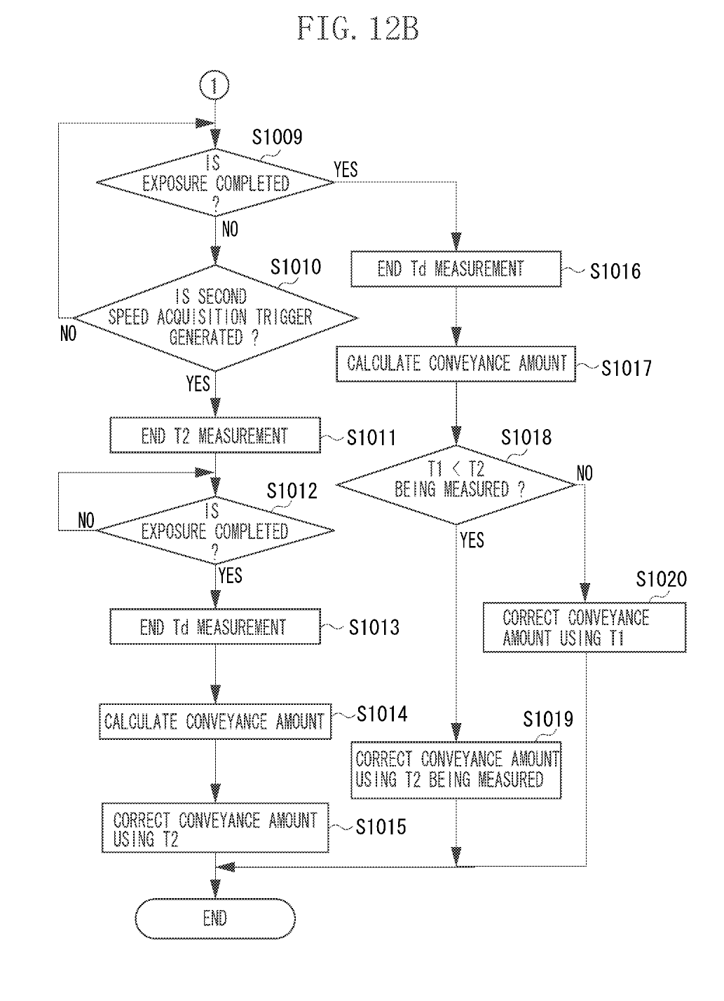

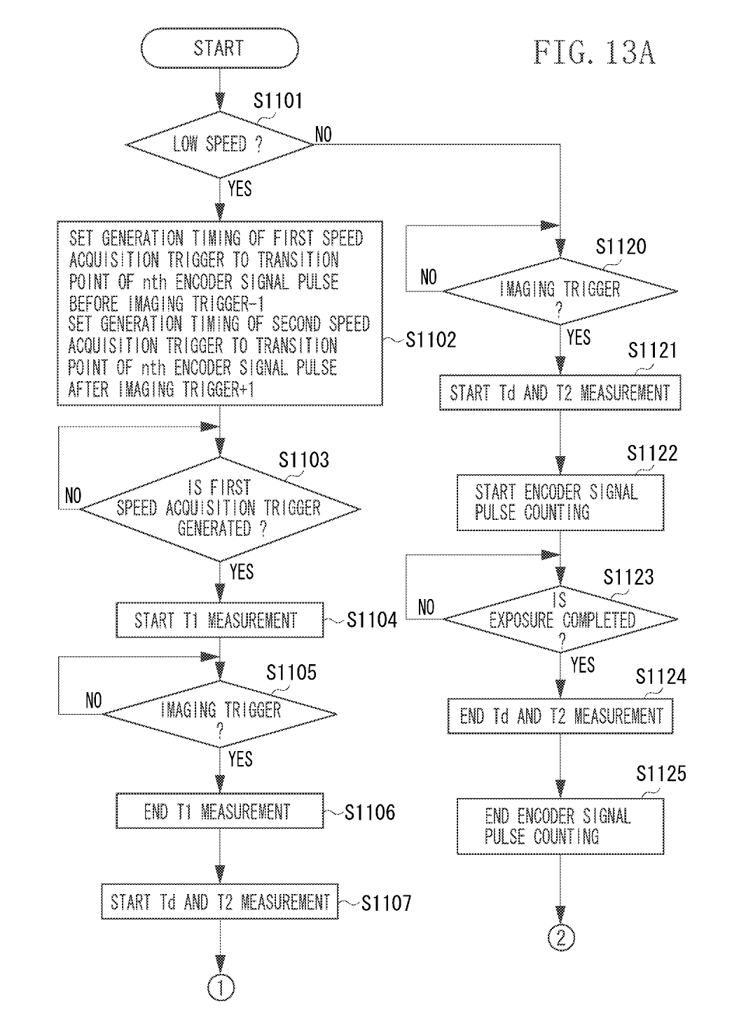

FIG. 12 (including FIG. 12A and FIG. 12B) is a flow chart illustrating processing of the second correction method described in FIG. 10. In step S1001, the processing determines whether the predicted subject's speed at the imaging timing of the direct sensor 134 is a high or low speed. The processing makes this determination from the target control value based on the speed profile, or the conveyance speed measured immediately before. When the processing determines that the predicted subject's speed is a high speed (NO in step S1001), the processing proceeds to step S1002. When the processing determines that the predicted subject's speed is a low speed (YES in step S1001), the processing proceeds to step S1003. In step S1002, the processing sets the generation timing of the first speed acquisition trigger signal 807 to a transition point of the n-th encoder signal pulse before the imaging trigger signal 808, and sets the generation timing of the second speed acquisition trigger signal 810 to a transition point of the n-th encoder signal pulse after the imaging trigger signal 808. In step S1003, the processing sets the generation timing of the first speed acquisition trigger signal 811 to a transition point of the encoder signal pulse immediately preceding the imaging trigger signal 812, and sets the generation timing of the second speed acquisition trigger signal 814 to a transition point of the encoder signal pulse immediately following the imaging trigger signal 812.

In step S1004, the processing waits until the first speed acquisition trigger signal 811 is generated. In step S1005, the processing starts measurement of the time period T1 by using the second timer included in the controller. In step S1006, the processing waits for the generation timing of the imaging trigger signal 812 and, when the imaging trigger signal 812 is detected, proceeds to step S1007. In step S1007, the processing completes measurement of the time period 11 by using the second timer. Upon completion of measurement of the time period T1, in step S1008, the processing starts measurement of the time lag Td by using the first timer, and measurement of the time period T2 by using the second timer. In step S1009, the processing determines whether or not exposure of the image sensor is completed. In step S1010, the processing waits for the generation timing of the second speed acquisition trigger signal 814.

In step S1009, when the exposure end timing is detected first, the processing proceeds to step S1016. In step S1010, when the generation timing of the second speed acquisition trigger signal 814 is detected first, the processing proceeds to step S1011. In step S1011, the processing completes measurement of the time period T2. Instep S1012, the processing waits for the exposure end timing of the image sensor. When exposure is completed, in step S1013, the processing subtracts a half of a known exposure period from the time lag Td measured using the first timer and then sets the resultant value as the time lag Td. Then, the processing completes measurement of the time lag Td.

In step S1014, the processing calculates a conveyance amount through image processing by using the first and second image data. As described with reference to FIG. 7, the processing extracts a template pattern from the first image data, and seeks an area in the second image data having a large correlation with the extracted template pattern through image processing to obtain an amount of movement of the object during the relevant time period. In step S1015, the processing obtains an average moving speed during the time period T2. To obtain an average moving speed, when the processing has determined that the predicted subject's speed is a low speed (YES in step S1001), the processing divides the amount of movement for one pulse signal from the encoder 133 by the time period T2. When the processing has determined that the predicted subject's speed is a high speed (NO in step S1001), the processing divides the amount of movement for n pulse signals of the encoder 133 by the time period T2. The processing multiplies the obtained average moving speed by the time lag Td to obtain a shift amount of the subject during the time lag Td (imaging delay). Then, the processing corrects the amount of movement obtained in step S1014 by using the obtained shift amount. A method for correcting the amount of movement has been described above. The processing completes this sequence when correction is completed.

When the processing proceeds to step S1016 as a result of the determination in step S1009, the processing performs the following processing. In step S1016, the processing subtracts a half of a known exposure period from the time lag Td measured using the first timer and then sets the resultant value as the time lag Td. Then, the processing completes measurement of the time lag Td. In step S1017, the processing calculates a conveyance amount by using a similar method as that in step S1014. In step S1018, the processing determines whether the time period T2 being measured is larger than the time period T1 measured. When the time period T2 being measured is larger than the time period T1 measured (YES in step S1018), the processing proceeds to step S1019. Otherwise (NO in step S1018), the processing proceeds to step S1020. In step S1019, the processing obtains an average moving speed during the time period T2 being measured. Then, the processing obtains a shift amount of the subject during the time lag Td (imaging delay), and corrects the amount of movement obtained in step S1017 by using the obtained shift amount. In step S1020, the processing obtains an average moving speed during the time period T1. Similar to step S1015, the calculation method differ between low-speed measurement and high-speed measurement. The processing multiplies the obtained average moving speed by the time lag Td to obtain a shift amount during the time lag Td. Then, the processing corrects the amount of movement obtained in step S1017 by using the obtained shift amount. After completion of correction, the processing completes this sequence.

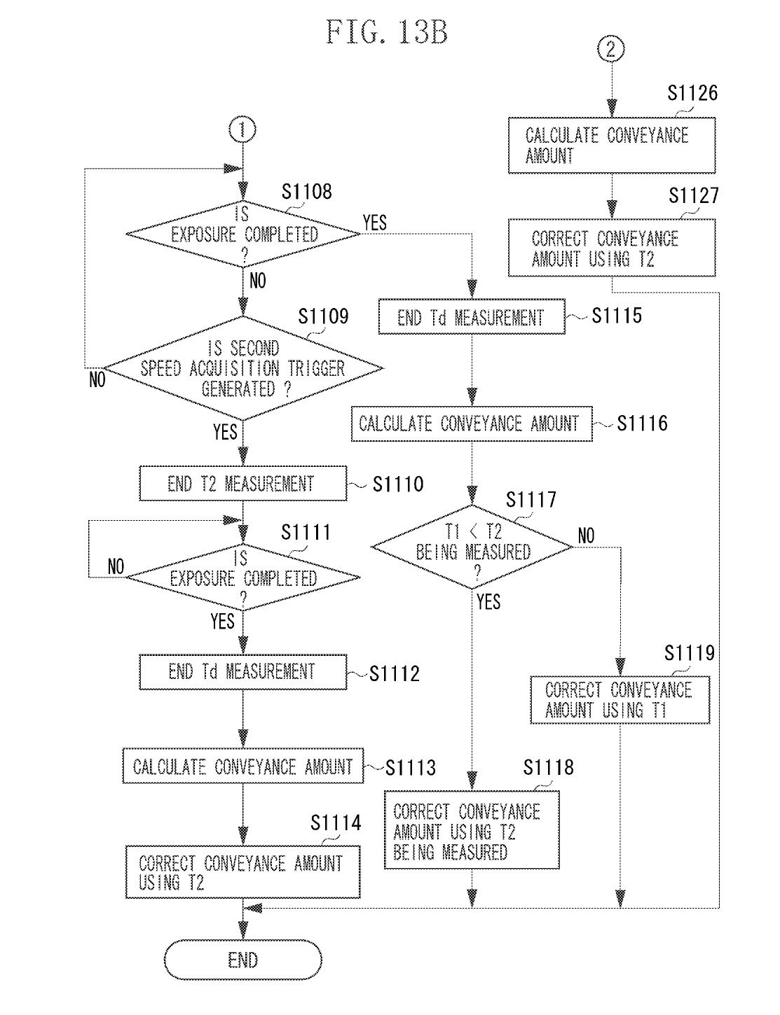

FIG. 13 (including FIG. 13A and FIG. 13B) is a flow chart illustrating processing of the third correction method described in FIG. 11. In step S1101, the processing determines whether the predicted subject's speed at the imaging timing of the direct sensor 134 is a high or low speed. When the processing determines that the predicted subject's speed is a low speed (YES in step S1101), the processing proceeds to step S1102. Processing of steps S1102 to S1119 is similar to processing of steps S1003 to S1120 in FIG. 12 and therefore descriptions for these steps will be omitted.

When the processing determines that the predicted subject's speed is a high speed (NO in step S1101), the processing proceeds to step S1120. In step S1120, the processing waits until the imaging trigger signal 906 is generated. In step S1121, the processing starts measurement of the time lag Td by using the first timer, and measurement of the time period T2 by using the second timer. In step S1122, the processing starts counting the number of transitions of the pulse of the encoder signal 903. In step S1123, the processing waits until exposure is completed. When exposure is completed, in step S1124, the processing completes measurement of the time period T2 by using the second timer. Then, the processing subtracts a half of a known exposure period from the time lag Td measured using the first timer and then sets the resultant value as the time lag Td. Then, the processing completes measurement of the time lag Td. In step S1125, the processing stops counting the number of transitions of the pulse of the encoder signal 903.

In step S1126, similar to step S1014 in FIG. 12, the processing calculates a conveyance amount through image processing by using the first and second image data. In step S1127, the processing calculates a conveyance amount during the relevant time period from the number of pulses counted in step S1125. The processing divides the obtained conveyance amount by the time period T2 obtained in step S1124 to obtain an average moving speed during the time period T2. The processing multiplies the obtained average moving speed by the time lag Td to obtain a shift amount during the time lag Td. Then, the processing corrects the amount of movement obtained in step S1126 by using the obtained shift amount. After completion of correction, the processing completes this sequence.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-250827 filed Oct. 30, 2009, which is hereby incorporated by reference herein in its entirety.

What is claimed is:

1. An apparatus comprising:
a sensor configured to capture an image of a surface of a moving object to acquire first and second data at different timings; and
a processing unit configured to extract a template pattern from the first data, and seek an area having a large correlation with the template pattern among areas in the second data to obtain an amount of movement of the object,
wherein the processing unit corrects the amount of movement by using a shift amount of the object during a time lag between generation timing of a trigger signal for acquiring data by using the sensor and the imaging timing.

2. The apparatus according to claim 1, further comprising:
a conveyance mechanism having a drive roller, configured to move the object; and
an encoder configured to detect a rotating state of the drive roller,
wherein the processing unit generates the imaging trigger signal based on a timing detected by the encoder.

3. The apparatus according to claim 2, wherein the drive of the drive roller is controlled based on the detected rotating state and the obtained amount of movement of the object.

4. The apparatus according to claim 2, wherein the processing unit acquires a duration of the time lag and a moving speed of the object during the time lag, and multiplies the obtained duration by the obtained moving speed to obtain a shift amount of the object during the time lag.

5. The apparatus according to claim 4, wherein the processing unit has a timer, measures a movement time for the object to move a predetermined distance detected by the encoder using the timer, and divides the predetermined distance by the measured movement time using the timer to acquire the moving speed.

6. The apparatus according to claim 4, wherein the processing unit has a timer, measures a time period by using the timer and a moving distance by using the encoder during a time period between the generation timing of the imaging trigger signal and an imaging end timing, and divides the moving distance by the measured time period to acquire the moving speed.

7. The apparatus according to claim 5, wherein the processing unit changes a calculation algorithm for acquiring the moving speed according to the speed of the object predicted at the imaging timing.

8. The apparatus according to claim 4, wherein the processing unit acquires the moving speed by using a target control value based on a speed profile used in conveyance control of the object.

9. The apparatus according to claim 4, wherein the processing unit considers the moving speed of the object measured before the generation timing of the imaging trigger signal as the moving speed.

10. The apparatus according to claim 4, wherein the processing unit has a timer and acquires the duration of the time lag through measurement by using the timer.

11. The apparatus according to claim 4, wherein the processing unit has a memory for prestoring the duration of the time lag and reads the memory to acquire the duration of the time lag.

12. The apparatus according to claim 1, wherein the processing unit obtains the shift amount in the first image data as a first shift amount and the shift amount in the second image data as a second shift amount, and corrects the amount of movement by using a correction value, to obtain the amount of movement.

13. A recording apparatus comprising:
the apparatus according to claims 1; and
a recording unit configured to perform recording on the moving object.

14. The recording apparatus according to claim 13, wherein the apparatus further comprises:
a conveyance mechanism having a drive roller, configured to move the object; and
an encoder configured to detect a rotating state of the drive roller,
wherein the processing unit generates the imaging trigger signal based on a timing detected by the encoder.

15. The recording according to claim 14, wherein the drive of the drive roller is controlled based on the detected rotating state and the obtained amount of movement of the object.

16. The recording apparatus according to claim 15, wherein the processing unit acquires a duration of the time lag and a moving speed of the object during the time lag, and multiplies the obtained duration by the obtained moving speed to obtain a shift amount of the object during the time lag.

17. The recording apparatus according to claim 15, wherein the processing unit has a timer, measures a movement time for the object to move a predetermined distance detected by the encoder using the timer, and divides the predetermined distance by the measured movement time using the timer to acquire the moving speed.

18. The recording apparatus according to claim 15, wherein the processing unit has a timer, measures a time period by using the timer and a moving distance by using the encoder during a time period between the generation timing of the imaging trigger signal and an imaging end timing, and divides the moving distance by the measured time period to acquire the moving speed.

19. The recording apparatus according to claim 15, wherein the processing unit acquires the moving speed by using a target control value based on a speed profile used in conveyance control of the object.

20. The recording apparatus according to claim 13, wherein the processing unit obtains the shift amount in the first image data as a first shift amount and the shift amount in the second image data as a second shift amount, and corrects the amount of movement by using a correction value, to obtain the amount of movement.
